(19) United States
(12) Patent Application Publication
(10) Pub. No.: US 2026/0366984 A1
(43) Pub. Date: Nov. 19, 2026

(54) OPTICAL SYSTEM

(71) Applicants: MYRIADE, Paris (FR); INSTITUT D'OPTIQUE THÉORIQUE ET APPLIQUÉE, Palaiseau (FR); UNIVERSITÉ DE BORDEAUX, Bordeaux (FR); CENTRE NATIONAL DE LA RECHERCHE SCIENTIFIQUE, Paris (FR)

(72) Inventors: Pierre Bon, Ambazac (FR); Minh Chau Nguyen, Limoges (FR)

(73) Assignees: MYRIADE, Paris (FR); INSTITUT D'OPTIQUE THÉORIQUE ET APPLIQUÉE, Palaiseau (FR); UNIVERSITÉ DE BORDEAUX, Bordeaux (FR); CENTRE NATIONAL DE LA RECHERCHE SCIENTIFIQUE, Paris (FR)

(21) Appl. No.: 19/145,713

(22) PCT Filed: Jan. 3, 2024
(86) PCT No.: PCT/EP2024/050060

§ 371 Date: Jul. 3, 2025

(30) Foreign Application Priority Data
Jan. 4, 2023 (FR) FR2300092

(51) Int. Cl. G01N 15/1434; G01N 15/14; G06T 7/50; G06T 7/62; H04N 23/56

(52) U.S. Cl. CPC G01N 15/1434; G06T 7/50; G06T 7/62; H04N 23/56; G01N 2015/1486; G06T 2207/10056; G06T 2207/30242

(57) ABSTRACT

An optical system includes a microscope having an optical axis, an illumination source for the microscope and a self-referenced phase imaging system. The illumination source illuminates an object space. The microscope conjugates an object plane of the object space with an image plane, the self-referenced phase imaging system being arranged in or in the vicinity of the image plane. The self-referenced phase imaging system produces a real image, in intensity and phase, of the object plane. The temporal coherence (TC) of the illumination source is between 0.4% and 6% and the spatial coherence (SC) of the illumination source, at the level of the self-referenced phase imaging system, is between 0.4% and 10%. The optical system further includes a processing unit configured to numerically propagate the real image along the optical axis.

### TECHNICAL FIELD

The present application relates to an optical system. Such a system makes it possible, in particular, to measure the concentration of nanoparticles without a priori knowledge of the nanoparticles and without having to modify the particles or their medium.

### BACKGROUND

In the prior art, the optical measurement of a concentration of nanoparticles encounters the problem of the provision of a tool to determine a measurement volume in which the nanoparticles are imaged. Indeed, the volume in which the nanoparticles are able to be detected depends on the size and nature of the nanoparticles and on the optical system. It is therefore difficult to optically measure a concentration of nanoparticles without a priori knowledge of the physical nature of the nanoparticles, and there is a need for an optical system that makes it possible to facilitate this measurement.

For the purposes of the present application, the following definitions apply:
“Temporal coherence TC” of a light source: the ratio of the wavelength range of the source divided by its central wavelength.
“Spatial coherence SC” of a light source in an optical system: the ratio of the numerical aperture of illumination of an optical system to the numerical aperture of collection.
“Self-referenced phase imaging system”: a self-referenced detection system or detector that provides the phase of an incident wave in addition to optical intensity. The system is self-referenced because it does not use a separate optical arm as a reference.
“Real image”: image of the intensity and phase of the wave field in an object plane, captured by the self-referenced phase imaging system that is used.
“Numerically propagated image”: image of the intensity and phase of the wave field in a plane parallel to the object plane; it is calculated numerically based on the real image using conventional propagation methods to solve the wave equation.
“Image volume”: volume imaged by numerically propagating the real image.
“Imaged nanoparticle” or “imaged particle”: nanoparticle that forms a sharp image or an image with a maximum spatial energy density in the real image (this is the case, in particular, for a nanoparticle in the object plane) or in numerically propagated images (this is the case, in particular, for a nanoparticle outside the object plane).
“Numerical depth of field”: thickness, in the direction of the optical axis, of the volume imaged by numerical propagation, in particular centered on the real image, in which nanoparticles are able to be imaged faithfully. This is the thickness in which the reconstruction of the volume imaged by numerical propagation, based on the real image, is valid. In other words, numerically propagated images reflect the reality of the object space. Objects physically present in the object space, and only these objects, are imaged on numerically propagated images that are considered to be faithful.
“White laser” or “super-continuum laser”: a source with high spatial coherence and quasi-zero temporal coherence.

The numerical depth of field defined above depends on the signal-to-noise ratio for the detection of the imaged objects. Further, the numerical depth of field is less than or equal to the depth of field (hereinafter referred to as “optical” depth of field for the sake of clarity) of the optical system that is used. Optical depth of field for its part depends on the spatial and temporal coherence of the light used for imaging.

Thus, for an optical system with spatial and temporal coherence (SC, TC) tending toward (0, 0), the limit to the optical depth of field imposed by these two parameters tends toward infinity, but the noise level increases, thereby making it difficult or even impossible to achieve any numerical propagation of the real image, and therefore limiting numerical depth of field. On the other hand, for an optical system with SC and/or TC tending toward infinity, noise drops but optical depth of field tends toward 0. The real image contains only perfectly focused objects. This also makes it difficult or even impossible to achieve any numerical propagation of the real image, and therefore limits the numerical depth of field.

Further, with fixed optical systems, the signal-to-noise ratio of an imaged nanoparticle depends on its size and nature. The numerical depth of field thus depends on the size and nature of the nanoparticles.

There is therefore a need for an optical system that is able to be used to produce a real image of nanoparticles, ideally without the need for a priori knowledge about the size and/or nature of the nanoparticles, and that is such that the numerical depth of field is satisfactory for this real image.

### General Presentation

In this context, the present application relates to an optical system comprising a microscope having an optical axis, an illumination source for the microscope and a self-referenced phase imaging system. The illumination source is configured to illuminate an object space. The microscope is configured to conjugate an object plane of the object space with an image plane, the self-referenced phase imaging system being arranged in the image plane or in the vicinity of the image plane. The self-referenced phase imaging system is configured to produce a real image, in intensity and phase, of the object plane. The temporal coherence of the illumination source is between 0.4% and 6% and the spatial coherence of the illumination source, at the level of the self-referenced phase imaging system, is between 0.4% and 10%. The optical system further comprises a processing unit configured to numerically propagate the real image along the optical axis.

In some embodiments, the temporal coherence of the illumination source is close to 2.2% and the spatial coherence of the illumination source, at the level of the self-referenced phase imaging system, is close to 2.5%.

In some embodiments, the illumination source is a white laser illuminating a bandpass filter. As a variant, the illumination source may be a white plasma source illuminating a bandpass filter or else a laser diode.

In some embodiments, the illumination source is configured to illuminate an object space in a solution of nanoparticles, and the processing unit is configured to: count the number of nanoparticles imaged in the real image,
numerically propagate the real image, along the optical axis, in an image volume of predetermined thickness,
count the number of nanoparticles imaged in the numerically propagated images,
calculate the size of the object volume corresponding to the image volume,
calculate the concentration of nanoparticles on the basis of the number (N) of imaged nanoparticles counted and the size of the object volume.

In some embodiments, the predetermined thickness is less than or equal to the numerical depth of field.

In some embodiments, in order to determine the numerical depth of field, the processing unit is configured to:
count the number of nanoparticles in a real image, obtained with the self-referenced phase imaging system, of a solution of nanoparticles;
numerically propagate the real image in image volumes of increasing variable thickness;
count the number of nanoparticles imaged in the numerically propagated images;
analyze the variation in the number of imaged particles counted as a function of the variable thickness of the image volume and identify a limit thickness of the image volume for which the number of imaged nanoparticles no longer increases with the variable thickness of the image volume and reaches a plateau,
determine the numerical depth of field on the basis of the identified limit thickness.

In some embodiments, the optical system further comprises a computer memory storing a chart that indicates, for various types of nanoparticle, the correspondence between the amplitude, hereinafter referred to as “amplitude R”, of a field formed of information concerning the real and/or imaginary parts of the wave field generated by an imaged nanoparticle and a numerical depth of field. The amplitude R may correspond in particular to the amplitude of a Rytov field.

In some embodiments, the processing unit refers to the chart to determine the numerical depth of field based on the amplitude R of a nanoparticle imaged in the real image.

In some embodiments, for a solution comprising a mixture of nanoparticles, the illumination source is configured to illuminate an object space in the solution and the processing unit is configured to:
count the nanoparticles imaged in the real image, measure the amplitudes R of these imaged nanoparticles and determine, with reference to a chart as described above, the numerical depths of field associated with each of these imaged particles;
numerically propagate the real image, along the optical axis, in an image volume of predetermined thickness, denoted D,
for each of the nanoparticles imaged in the numerically propagated images in planes of the image volume, verify, using the chart, whether the amplitude R of the nanoparticle corresponds to a numerical depth of field, denoted H, greater than or equal to twice the distance between the numerically propagated image in which the nanoparticle is imaged and the real image, and retain the particle for the count if so, and not retain it for the count if not;
for each counted nanoparticle, calculate the associated object volume corresponding, if H≥D, to the image volume of thickness D or, if H<D, to an image volume of thickness equal to the numerical depth of field H associated with the nanoparticle; and
calculate the concentration of nanoparticles, which is equal to the sum, over all of the counted nanoparticles, of the reciprocals of the associated object volumes.

The abovementioned features and advantages, along with others, will become apparent on reading the following detailed description. This detailed description refers to the appended drawings.

### BRIEF DESCRIPTION OF THE DRAWINGS

FIG. 1 This figure is a graph showing the number N of particles imaged in an image volume of variable thickness Dv, in micrometers (μm).

FIG. 2 This figure is a graph showing numerical depth of field H, in micrometers (μm), as a function of the amplitude R, in arbitrary units (a.u.), of the Rytov peaks of the imaged nanoparticles.

FIG. 3 This figure shows one example of a spatial coherence (SC) and temporal coherence (TC) domain.

### DETAILED DESCRIPTION

One example of an optical system according to the invention comprises a microscope having an optical axis, an illumination source, a self-referenced phase imaging system, referred to more simply as “detector”, and a processing unit configured to numerically propagate the real image. The illumination source illuminates the microscope, which conjugates an object plane and an image plane containing the detector. The detector produces phase and intensity images.

The spatial coherence SC and temporal coherence TC domain of the source is chosen so as to enable a faithful numerical propagation, based on the real image, of a solution of nanoparticles so as to determine the position of the nanoparticles in the object volume. Numerical propagation consists in numerically propagating the real image, along the optical axis, in an image volume of predetermined thickness less than or equal to the numerical depth of field.

Numerical propagation is faithful only for a certain thickness of the image volume, distributed symmetrically on either side of the real image. Beyond this limit thickness, numerically propagated images exhibit artefacts and no longer represent the reality of the solution sample. This limit thickness corresponds to numerical depth of field.

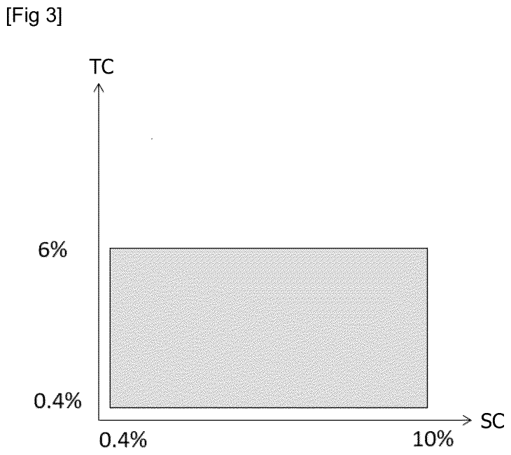

In particular, use is made of an illumination source with spatial coherence SC and temporal coherence TC which are chosen or modified so as to make the source operate in the desired coherence domain. FIG. 3 shows the coherence domain (SC and TC) chosen for the illumination source. This domain is limited as follows: from 0.4% to 6% in the temporal coherence (TC) domain and from 0.4% to 10% in the spatial coherence (SC) domain. This domain encompasses the operating mode TC=2.2% and SC=2.5%, which is considered to be optimal.

To implement the invention, a person skilled in the art may consider in particular the following illumination sources:
a laser diode (Thorlabs L405P150: wavelength 405 nm and power 150 mW), temporal coherence estimated at TC=0.25% (1 nm spectral width over a central wavelength of 405 nm). Wavelength modulation during the integration interval of the detector used (for example 1 ms) may be applied to get closer to the temporal coherence TC=2.2% considered to be optimal;
a white laser, also referred to as a “super-continuum laser”, filtered by a bandpass filter (super-continuum laser referenced Leukos Electro VIS 430);
a white plasma source, powerful enough for the nanoparticle signal to be greater than noise, filtered by a bandpass filter;
an illumination source that is a source with a temporal coherence TC tending toward 0 (for example, a laser diode), in combination with a temporal coherence adjustment method based on high-frequency wavelength variation (electronic trigger);
an illumination source that is a source with a spatial coherence SC tending toward 0 (for example a source with a collimation system), in combination with a spatial coherence adjustment method such as, in particular: based on a system for focusing or diversifying the beam, based on coupling with a multimode optical fiber, based on high-frequency movement (rotation/vibration/scanning) of the optical elements;
a superluminescent diode.

It should be noted that a spatial coherence of the order of 2% (therefore close to the value SC=2.5% considered to be optimal) with known microscopes proves satisfactory for implementing the invention.

The teaching in the present application, when it presents a spatial and temporal coherence domain, does not establish any equivalence link between these two concepts, which are different by nature. The constraints of belonging to temporal and spatial coherence intervals are therefore understood to be cumulative conditions that are to be satisfied simultaneously.

Further, it should be understood that a point of zero spatial coherence (SC=0) or zero temporal coherence (TC=0) is of no physical significance. Consequently, in the present application, a spatial or temporal coherence interval extending between 0 and an upper bound is an open interval not comprising the value 0.

The spatial and temporal coherence domain shown in FIG. 3 is hereinafter referred to as the “main domain”. As indicated above, the operating mode considered to be optimal for the invention, within the main domain, is obtained for TC=0.022 (2.2%) and SC=0.025 (2.5%).

Making TC or SC tend toward 0 is not a preferred embodiment, because the presence of optical noise due to spatial and temporal coherence (speckle or laser granularity) degrades particle detection by raising the background noise level, thereby reducing the number of particles detected and the possible propagation volume. A domain suitable for implementing the invention is therefore a domain excluding TC=0 or SC=0.

In the present application, the temporal coherence TC of the illumination source is considered to be close to 2.2% and the spatial coherence SC of the illumination source at the level of the self-referenced phase imaging system is considered to be close to 2.5% if these two parameters TC, SC are within an interval containing the value TC=2.2% and within an interval containing the value SC=2.5%, respectively, these two intervals being strictly included, respectively, in the intervals of the abovementioned main domain shown in FIG. 3, that is to say between 0.4% and 6% for TC and between 0.4% and 10% for SC. In other words, with the combination TC=2.2% and SC=2.5% being considered to be an “optimum operating point” of the system, closeness to the optimum point within the meaning of the present application is any subdomain of the main domain containing the optimum point. For example, mention may be made of a subdomain with a range of 1.7% to 2.7% for TC and a range of 2% to 3% for SC.

In the prior art, a low but relatively common value for spatial coherence is typically SC=0.1%. A document from the prior art that teaches to minimize spatial coherence or to make it tend toward 0 should therefore be interpreted as teaching to choose values of SC less than 0.1%. This would therefore not correspond to the conditions of implementing the invention within the spatial coherence SC interval of [0.4%; 10%].

In the prior art, a low but relatively common value for temporal coherence is typically TC=0.02% (without this value being related to the common low spatial coherence value SC mentioned above). A document from the prior art that teaches to minimize temporal coherence TC should therefore be interpreted as teaching to choose values of TC less than 0.02%. This would therefore not correspond to the conditions of implementing the invention within the temporal coherence TC interval of [0.4%; 6%].

To produce such an optical system, it will be sufficient, for a given illumination source, either to verify that it corresponds to the abovementioned spatial and temporal coherence domain or to verify that the signal-to-noise ratio that it provides on a detector allows detection of nanoparticles and numerical propagation of the real image.

In the present application, a detector producing phase and intensity images is understood to be a detector producing an actual phase measurement, but also equivalently a quantity capable of reconstructing the phase information as a quantity proportional to phase, as an optical path difference, or as one or more phase gradients, which allow it to be reconstructed by integration.

By way of example, the following devices may be used as a detector:
a multi-lateral shift interferometry device using a modified Hartmann mask, for example by superposition of an amplitude grating having a given period p and a phase grating having a period 2.p, such as for example a detector referenced by the name “SID4” and marketed by the company “Phasics”;
wavefront analyzers, used to establish a phase map of a wavefront, combined with an intensity detector for analyzing the phase and intensity of a wave simultaneously and with a common spatial reference;
a wavefront analyzer or imager known from the prior art, such as a curvature analyzer, a Shack-Hartmann sensor, a quantitative phase microscopy assembly such as for example a self-referenced numerical holography device.

The determination of numerical depth of field in order to calculate the concentration of nanoparticles is based on numerical propagation of the real image in order to calculate the wave field in the object volume. To solve the wave equation in an inhomogeneous medium (as is the case for a medium containing a population of nanoparticles) and to carry out numerical propagation, it is possible to apply numerous approaches or methods known from the prior art, including in particular: the ray method (or geometric optics), the Born weak scattering method, the Rytov approach, parabolic approximation and the intensity transfer equation.

In some embodiments, use is made of a microscope that revolves about an optical axis coincident with the z-axis of an orthonormal reference frame (O, x, y, z) in an image space, and a surface detector S, arranged in the image plane z=0 and providing a measurement of the intensity and phase of the complex field incident on this detector. This gives rise to the formation, on the detector, of a real intensity and phase image, also referred to as a holographic image, of nanoparticles arranged in the object volume around an object plane optically conjugated with the plane of the detector.

It is possible to count the number of nanoparticles imaged n(z=0) in the real image, and then, using numerical propagation in steps of thickness d, symmetrically with respect to the image plane (that is to say the plane of the real image), to obtain images of planes spaced from the detector by d/2 and spaced from one another by d. It is then possible to count the number of nanoparticles imaged n(−d/2) and n(d/2) in these two planes. Addition is carried out to obtain a number of particles imaged N(d)=n(0)+n(−d/2)+n(d/2) in the image volume of thickness d, that is to say by summing the particles imaged in planes within the image volume (here the plane of the detector) and on the surface of the image volume of thickness d.

It is easy to demonstrate that, by also progressively propagating the image at −d/2 in the plane at −d and the image at +d/2 in the plane at +d, that is to say by increasing the image volume in steps of thickness d symmetrically with respect to the image, it is possible to count the number of particles imaged by two numerical propagations in two new planes located outside the image volume for which the number of particles is known beforehand. The known number of particles imaged in the internal volume is added to the new planes and the number of particles imaged in these new planes, step by step. Thus, for a variable image-volume thickness Dv=k*d (k being a positive integer):

N((k+1)*d)=N(k*d)+n(k*d/2)+n(−k*d/2).

It is then possible to plot the graph or curve N(Dv) representative of the number N of particles imaged as a function of variable thickness Dv for an experiment or a mean curve for multiple experiments (multiple real images of one and the same solution of nanoparticles).

For a population of given nanoparticles (fixed size and nature), it is observed for a source with a controlled spatial and temporal coherence that the number N of imaged particles (which may be a mean if multiple experiments are carried out) present in an increasingly large image volume does not increase linearly, but peaks at a constant value over a plateau or plateau zone P that extends in a manner projecting along the thickness axis Dv, over a thickness range k1*d ≤Dv≤k2*d, with k1<k2, and along the N axis keeping a substantially constant value, to within measurement errors. It is then possible to determine the value H=k1*d as being the numerical depth of field for the experimental device used and for the population of nanoparticles imaged.

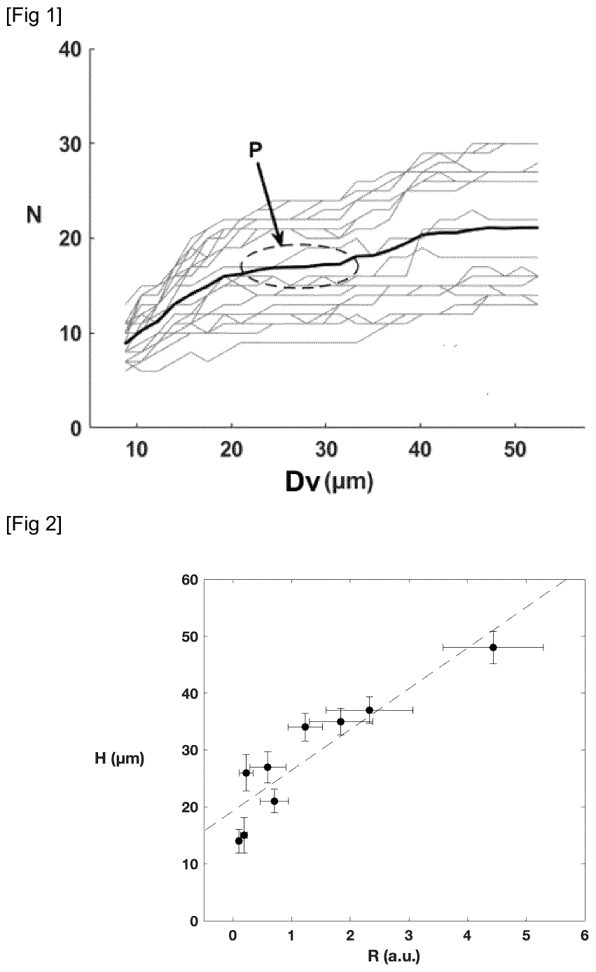

The above explanations are illustrated by the example of FIG. 1. In this example, the particles that are used are polystyrene particles with a diameter of 100 nm. FIG. 1 is a graph showing the number N of particles imaged in an image volume V of variable thickness Dv in micrometers (μm) after numerical propagation of the real image in the image volume V. This image volume V is centered on the plane of the real image and its thickness Dv increases symmetrically on either side of the real image. The imaged particles are counted in numerically propagated images that are spaced from one another so as to reconstruct the image volume V. This operation was carried out for multiple real images of one and the same sample (bright lines), and the relationships are then averaged to obtain the thick curve N(Dv). This curve N(Dv) exhibits monotonic growth up to a ceiling over a plateau zone P (surrounded by dashed lines in FIG. 1), within which the number N of imaged particles is substantially stable with Dv. There is thus a limit thickness starting from which the number N of imaged particles peaks at a certain value, denoted N(H), in the zone P. In the example in the figure, N(H) is close to 16. The numerical depth of field H corresponds to said limit thickness. In the example in the figure, the numerical depth of field H is estimated to be equal to 25 μm.

For thicknesses Dv greater than H, reconstruction of the volume by numerical propagation is considered to no longer be faithful to the reality of the object volume. Indeed, the fact that N peaks and then increases with Dv (for Dv>H) does not correspond to physical reality for a homogeneous sample of nanoparticles (for which N must constantly increase with Dv). For Dv>H, numerical propagation no longer makes it possible to reconstruct images of objects physically present in the object volume, but creates images of objects that are not present in the object volume.

In order to avoid or limit counting artefacts as much as possible, numerical propagation over a distance (that is to say a predetermined image-volume thickness D) chosen to be less than or equal to the numerical depth of field H determined with reference nanoparticles will be one preferred mode of implementation for determining the concentration of a population of nanoparticles without a priori knowledge thereof.

The step d is chosen to be less than the axial resolution of the microscope and to allow faithful sampling of the volume.

The numerical depth of field value for a nanoparticle depends on the volume of the particle and the modulus of the difference in complex index between the particle and the surrounding medium at a given wavelength, with a given SC and TC, and a given imaging system (numerical aperture of illumination and collection).

The inventors discovered that the Rytov approach was able to be applied with particular relevance to the calculation of concentrations of nanoparticles. Indeed, calculating the complex Rytov field and in particular the intensity thereof makes it easier to detect nanoparticles imaged in the real image and in numerically propagated images.

The Rytov approach described here is valid in the previously mentioned spatial coherence SC and temporal coherence TC domains of the illumination source.

The intensity I(x, y, zi) and phase phi(x, y, zi) in the plane of the detector (real image) (zi=0) or in the plane of a numerically propagated image (zi other than zero) are taken as a basis for forming the complex Rytov field r(x, y, zi) using formulas known from the prior art, in other fields of application.

This is followed by formation of an intensity Rytov image R(x, y, zi) in the plane zi using the square of the modulus in this plane of the complex Rytov amplitude according to the formula: R(x, y, zi)=|r(x, y, zi)|2. As an alternative, a Rytov amplitude image may be obtained for the same purposes, by forming the square root of R as a function of x, y in the plane zi.

Using Rytov intensity is particularly effective for detecting imaged nanoparticles, whether in real or propagated images. Indeed, Rytov intensity or amplitude make it possible, for a nanoparticle that is sharp in the plane under consideration, to obtain a positive signal on a zero background, regardless of the nature of the nanoparticle (whether the signal is contained in the real or imaginary part of the real or propagated image, it will be visible in the intensity or amplitude of the Rytov field).

Using Rytov intensity is therefore a preferred way to identify and count the nanoparticles imaged in the image volume after numerical propagation (by calculating the Rytov field for each numerically propagated image in the image volume and by detecting Rytov intensity or amplitude in the corresponding image), as described above. The calculation of the Rytov field is therefore useful for counting the imaged nanoparticles. In addition, the inventors discovered that the intensity or amplitude of the Rytov field is characteristic of the associated numerical depth of field. Indeed, when the complex amplitude information is expressed in the form of the Rytov field, for an optical system suitable for the TC and SC coherence regime, the result is that the numerical depth of field is now only a function of Rytov intensity or amplitude, in the sense that nanoparticles having the same Rytov intensity or amplitude are able to be detected in one and the same numerical depth of field, even if their optical index or volume are different. This result is illustrated by FIG. 2. This figure is a graph showing numerical depth of field H, in micrometers (μm), as a function of the mean amplitude R of the Rytov peaks, in arbitrary units (a.u.), of the imaged nanoparticles. Here, the chosen observable is the amplitude of the Rytov field of the numerically propagated complex field, in the image volume of thickness equal to the numerical depth of field H. Each point and its associated statistic correspond to homogeneous samples of different nanoparticles, the nanoparticles of each sample having a fixed diameter and nature.

FIG. 2 thus shows the value of the mean Rytov amplitude R for samples of different nanoparticles (each sample is homogeneous in terms of composition and size) as a function of numerical depth of field H, determined using the above-described method for determining the plateau P (see FIG. 1). Each point corresponds to a different sample, that is to say to a different pair (mean diameter, materials). The following samples are shown:
Polystyrene (PS) 60 nm, PS 80 nm, PS 100 nm, PS 150 nm, PS 200 nm,
Gold 60 nm, Gold 100 nm
Silver 100 nm and
Diamond 80 nm.

It is observed that there is a relationship between the numerical depth of field H and the amplitude R of the Rytov peaks, or Rytov amplitude. This relationship may be approximated by the dashed line on the graph. This graph may therefore be used as a chart insofar as, for a given optical system, operating in a given SC and TC regime, it is possible to determine the numerical depth of field H associated with an unknown nanoparticle by simply measuring the Rytov amplitude R of this nanoparticle. This avoids having to systematically carry out the method for determining numerical depth of field H by propagating the real image, counting the imaged nanoparticles and determining the plateau P (see FIG. 1). Such a chart makes it possible to determine a calibration of the numerical depth of field of a fixed optical system as a function of the Rytov amplitude of the objects imaged by this system.

Thus, using the Rytov approach, numerical depth of field is able to be determined directly by measuring the Rytov amplitude with reference to a chart, that is to say a graph or table indicating the correspondence between the Rytov amplitude R and the numerical depth of field H. The Rytov amplitude is therefore a measurement of choice of numerical depth of field for a type of nanoparticle in an optical system with a view to measuring a concentration of the nanoparticles.

The result is that, for an optical system in which the correspondence between the Rytov amplitude R and the numerical depth of field H is known from a chart as described above, it is possible, for a single nanoparticle imaged in terms of intensity and phase on the detector, to know, by forming the image of the Rytov amplitude and by looking for a signal peak in the Rytov image, both locate the imaged nanoparticle and derive therefrom the numerical depth of field associated with this nanoparticle.

The Rytov field may be replaced by another combination of the information concerning the real and imaginary parts of the wave field or, if a priori knowledge about the response of the particles is known, by only the real component or the imaginary component. In other words, instead of the Rytov field, other fields formed of information concerning the real and/or imaginary parts of the wave field may be used.

The proposed optical system and measuring method therefore make it possible to obtain a measurement of the concentration of any nanoparticles, regardless of the physical nature of the nanoparticles and their size, and without having to calibrate the system with samples of known concentrations.

Indeed, determining numerical depth of field makes it possible to delimit the image volume in which the reconstruction by numerical propagation based on the real image is faithful to the reality of the imaged sample. Numerical propagation is therefore carried out for this volume, the imaged nanoparticles are counted for this volume and the concentration of the nanoparticles is calculated as being equal to the number of nanoparticles counted divided by the volume. This volume is controlled and defined numerically, and is not the result of a hypothesis or calibration to define this volume. This concentration measurement is carried out only based on the optical signal from the sample, and does not require prior calibration with samples of known concentrations.

Knowing numerical depth of field makes it possible to avoid numerically propagating the real image over excessively large image volume thicknesses, thereby giving a better measurement of concentration (propagation artefacts are not counted as imaged nanoparticles) while at the same time limiting numerical propagation calculation time.

The use of the chart, which is characteristic of a given optical system, makes it possible to determine numerical depth of field based on the measurement of the Rytov amplitude of a nanoparticle imaged in the real image. This limits calculation time even further insofar as the initial propagation step, over an increasing thickness Dv (FIG. 1) used to determine the numerical depth of field H, is not necessary. Only propagation over a thickness D less than or equal to the depth H is carried out to allow counting.

For samples of nanoparticles that are heterogeneous (in terms of composition and size), it is also possible to calculate the concentration of the sample using the methods described above. In such a mixture, the nanoparticles have different numerical depths of field. Care must be taken to ensure that imaged particles in the image volume that contribute to the calculation of the concentration are not numerical propagation artefacts. This is achieved by using the chart to verify, for each of the nanoparticles imaged in the successive numerically propagated images in the image volume (thickness D), that the amplitude R of the nanoparticle corresponds to a numerical depth of field H greater than or equal to twice the distance between the numerically propagated image in which the nanoparticle is imaged and the real image. If this condition is verified, the particle is retained; if it is not verified, the nanoparticle is not retained. It is also necessary to take into account, when calculating the concentration to be considered, for each nanoparticle, the image volume in which it was counted. For the nanoparticles that are retained:
if H<D, then this volume has the thickness H;
if H≥D, then this volume has the thickness D.

The final concentration is equal to the sum, over the retained particles, of the reciprocal of these volumes.

Assuming that lateral and axial magnification is known between the object space and the image space, the following relationship gives the correspondence between the object volume V1 and the image volume V2=V1.gx.gy.gz, where gx=gy is the lateral magnification of the optical system between the object plane and the image plane and gz is the axial magnification in the vicinity of the plane of the detector in the direction z of the optical axis of the optical system used for conjugation, assumed to be an axis of revolution.

To calculate an object volume based on the image volume, it is expediently possible to use the surface of the detector and the lateral and axial magnification of the optical system to complete the dimensions of the image volume and then to obtain the object volume.

The present application is industrially applicable in particular in the field of measuring concentrations of nanoparticles.

The proposed device and method are particularly suitable for measuring the concentration of nanoparticles in solution, subjected to Brownian motion, because the availability of intensity and phase in self-referenced fashion over time (producing a film) makes it possible to envisage tracking and refocusing nanoparticles in images propagated outside the plane of the real image within the meaning of the present application and to obtain a signal-to-noise ratio capable of implementing the teaching of the present application, by averaging successive numerically propagated images of one and the same particle.

1-10. (canceled)

11. An optical system for measuring the concentration of nanoparticles in solution, the optical system comprising a microscope having an optical axis, an illumination source for the microscope and a self-referenced phase imaging system,
wherein the illumination source is configured to illuminate an object space in a solution of nanoparticles,
wherein the microscope is configured to conjugate an object plane of the object space with an image plane, the self-referenced phase imaging system being arranged in or in the vicinity of the image plane, and
wherein the self-referenced phase imaging system is configured to produce a real image, in intensity and phase, of the object plane,
wherein the temporal coherence of the illumination source is between 0.4% and 6% and the spatial coherence of the illumination source, at the level of the self-referenced phase imaging system, is between 0.4% and 10%,
the optical system further comprising a processing unit configured to:
count the number of nanoparticles imaged in the real image,
numerically propagate the real image, along the optical axis, in an image volume of predetermined thickness,
count the number of nanoparticles imaged in images propagated numerically from the real image,
calculate the size of the object volume corresponding to the image volume,
calculate the concentration of nanoparticles on the basis of the number of imaged nanoparticles counted and the size of the object volume.

12. The optical system of claim 11, wherein the predetermined thickness of the image volume is less than or equal to the numerical depth of field, and wherein, for determining the numerical depth of field, the processing unit is configured to:
count the number of nanoparticles in a first real image, obtained with the self-referenced phase imaging system, of a solution of nanoparticles;
numerically propagate the first real image in a first image volume of increasing variable thickness;
count the number of nanoparticles imaged in images propagated numerically from the first real image;
analyze the variation in the number of imaged nanoparticles counted as a function of the variable thickness of the first image volume and identify a limit thickness of the first image volume for which the number of imaged nanoparticles no longer increases with the variable thickness of the first image volume and reaches a plateau, and
determine the numerical depth of field on the basis of the identified limit thickness.

13. The optical system of claim 11, wherein the system further comprises a computer memory storing a chart that indicates, for various types of nanoparticle, the correspondence between a numerical depth of field and the amplitude, denoted amplitude R, of a field formed of information concerning the real and/or imaginary parts of the wave field generated by an imaged nanoparticle.

14. The optical system of claim 13, wherein the predetermined thickness is less than or equal to a numerical depth of field, and wherein the processing unit refers to the chart to determine the numerical depth of field based on the amplitude R of a nanoparticle imaged in the real image.

15. The optical system of claim 11, further comprising a computer memory storing a chart that indicates, for various types of nanoparticle, the correspondence between a numerical depth of field and the amplitude, denoted amplitude R, of a field formed of information concerning the real and/or imaginary parts of the wave field generated by an imaged nanoparticle,
wherein the illumination source is configured to illuminate an object space in the solution of nanoparticles, the solution comprising a mixture of nanoparticles,
wherein the processing unit is configured to:
count the nanoparticles imaged in the real image, measure the amplitude R thereof and determine, with reference to the chart, the numerical depth of field associated with each of these imaged nanoparticles;
numerically propagate the real image, along the optical axis, in the image volume of predetermined thickness, denoted D;
for each of the nanoparticles imaged in the numerically propagated images of the image volume, verify, using the chart, whether the amplitude R of the nanoparticle corresponds to a numerical depth of field, denoted H, greater than or equal to twice the distance between the numerically propagated image in which the nanoparticle is imaged and the real image, and retain the nanoparticle for the count if so, and not retain it for the count if not;
for each counted nanoparticle, calculate an associated object volume corresponding, if H≥D, to the image volume of thickness D or, if H<D, to an image volume of thickness equal to the numerical depth of field H associated with the nanoparticle; and
calculate the concentration of nanoparticles, which is equal to the sum, over all of the counted nanoparticles, of the reciprocals of the associated object volumes.

16. The optical system of claim 11, wherein the temporal coherence of the illumination source is close to 2.2% and the spatial coherence of the illumination source, at the level of the self-referenced phase imaging system, is close to 2.5%.

17. The optical system of claim 11, wherein the illumination source is a white laser illuminating a bandpass filter.

18. The optical system of claim 11, wherein the illumination source is a white plasma source illuminating a bandpass filter.

19. The optical system of claim 11, wherein the illumination source is a laser diode.
